(19) United States
(12) Patent Application Publication
(10) Pub. No.: US 2026/0353175 A1
(43) Pub. Date: Nov. 5, 2026

(54) Information Obtaining Method and Communication Device

(71) Applicant: VIVO MOBILE COMMUNICATION CO., LTD., Dongguan (CN)

(72) Inventor: Li Chen, Dongguan (CN)

(21) Appl. No.: 19/713,232

(22) Filed: Jun. 18, 2026

Related U.S. Application Data
(63) Continuation of application No. PCT/CN2024/139711, filed on Dec. 16, 2024.

(30) Foreign Application Priority Data
Dec. 21, 2023 (CN) 202311775709.4

(51) Int. Cl. H04W 28/02

(52) U.S. Cl. CPC H04W 28/0268

(57) ABSTRACT

An information obtaining method includes: receiving, by a first node, first information from a second node, where the first information is information related to a processing requirement between multiple streams or multiple packets, and the processing requirement includes at least one of the following: a coordination requirement or a synchronization requirement. The first node and the second node are different nodes, or the first node and the second node are different protocol layers in a same node.

### CROSS-REFERENCE TO RELATED APPLICATIONS

This application is a Bypass Continuation Application of International Patent Application No. PCT/CN2024/139711 filed Dec. 16, 2024, and claims priority to Chinese Patent Application No. 202311775709.4 filed Dec. 21, 2023, the disclosures of which are hereby incorporated by reference in their entireties.

### BACKGROUND OF THE INVENTION

### Field of the Invention

This application belongs to the field of communication technologies, and in particular, relates to an information obtaining method and a communication device.

### Description of Related Art

An existing extended reality (XR) or cloud gaming (CG) service may include multiple streams or quality of service (QoS) flows. Different streams or QoS flows may be processed differently. However, to improve user experience, synchronization and coordination between different streams or QoS flows need to be ensured.

### SUMMARY OF THE INVENTION

According to a first aspect, an information obtaining method is provided. The method includes: receiving, by a first node, first information from a second node, where the first information is information related to a processing requirement between multiple streams or multiple packets, and the processing requirement includes at least one of the following: a coordination requirement or a synchronization requirement. The first node and the second node are different nodes, or the first node and the second node are different protocol layers in a same node.

According to a second aspect, an information obtaining apparatus is provided. The apparatus is applied to a first node, and includes a receiving module. The receiving module is configured to receive first information from a second node, where the first information is information related to a processing requirement between multiple streams or multiple packets, and the processing requirement includes at least one of the following: a coordination requirement or a synchronization requirement. The first node and the second node are different nodes, or the first node and the second node are different protocol layers in a same node.

According to a third aspect, a communication device is provided. The communication device includes a processor and a memory, the memory stores a program or instructions executable on the processor, and when the program or instructions are executed by the processor, the steps of the method according to the first aspect are implemented.

According to a fourth aspect, a communication device is provided, including a processor and a communication interface. The communication interface is configured to receive first information from a second node, where the first information is information related to a processing requirement between multiple streams or multiple packets, and the processing requirement includes at least one of the following: a coordination requirement or a synchronization requirement. The first node and the second node are different nodes, or the first node and the second node are different protocol layers in a same node.

According to a fifth aspect, an information obtaining method is provided. The method includes: sending, by a second node, first information to a first node, where the first information is information related to a processing requirement between multiple streams or multiple packets, and the processing requirement includes at least one of the following: a coordination requirement or a synchronization requirement. The first node and the second node are different nodes, or the first node and the second node are different protocol layers in a same node.

According to a sixth aspect, an information obtaining apparatus is provided. The apparatus is applied to a second node, and includes a sending module. The sending module is configured to send first information to a first node, where the first information is information related to a processing requirement between multiple streams or multiple packets, and the processing requirement includes at least one of the following: a coordination requirement or a synchronization requirement. The first node and the second node are different nodes, or the first node and the second node are different protocol layers in a same node.

According to a seventh aspect, a communication device is provided. The communication device includes a processor and a memory, the memory stores a program or instructions executable on the processor, and when the program or instructions are executed by the processor, the steps of the method according to the fifth aspect are implemented.

According to an eighth aspect, a communication device is provided, including a processor and a communication interface. The communication interface is configured to send first information to a first node, where the first information is information related to a processing requirement between multiple streams or multiple packets, and the processing requirement includes at least one of the following: a coordination requirement or a synchronization requirement. The first node and the second node are different nodes, or the first node and the second node are different protocol layers in a same node.

According to a ninth aspect, a non-transitory readable storage medium is provided. The non-transitory readable storage medium stores a program or instructions, and when the program or instructions are executed by a processor, the steps of the method according to the first aspect or the steps of the method according to the fifth aspect are implemented.

According to a tenth aspect, a chip is provided. The chip includes a processor and a communication interface. The communication interface is coupled to the processor, and the processor is configured to run a program or instructions, to implement the steps of the method according to the first aspect or the steps of the method according to the fifth aspect.

According to an eleventh aspect, a computer program product/program product is provided. The computer program product/program product is stored in a non-transitory storage medium, and the program/program product is executed by at least one processor to implement the steps of the information obtaining method according to the first aspect or the steps of the information obtaining method according to the fifth aspect.

According to a twelfth aspect, a wireless communication system is provided, including a first node and a second node. The first node may be configured to perform the steps of the method according to the first aspect, and the second node may be configured to perform the steps of the method according to the fifth aspect.

### BRIEF DESCRIPTION OF THE DRAWINGS

FIG. 1 is a schematic architecture diagram of a wireless communication system according to an embodiment of this application;

FIG. 2A is a first schematic architecture diagram of a protocol stack according to a related technology;

FIG. 2B is a second schematic architecture diagram of a protocol stack according to a related technology;

FIG. 3 is a first flowchart of an information obtaining method according to an embodiment of this application;

FIG. 4 is a second flowchart of an information obtaining method according to an embodiment of this application;

FIG. 5 is a first schematic structural diagram of an information obtaining apparatus according to an embodiment of this application;

FIG. 6 is a second schematic structural diagram of an information obtaining apparatus according to an embodiment of this application;

FIG. 7 is a schematic diagram of a hardware structure of a communication device according to an embodiment of this application;

FIG. 8 is a schematic diagram of a hardware structure of a terminal according to an embodiment of this application;

FIG. 9 is a first schematic diagram of a hardware structure of a network side device according to an embodiment of this application; and

FIG. 10 is a second schematic diagram of a hardware structure of a network side device according to an embodiment of this application.

### DESCRIPTION OF THE INVENTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

Terms such as "first" and "second" in this application are used to distinguish between similar objects, and are not used to describe a specific order or sequence. It should be understood that, the terms used in such a way are interchangeable in proper circumstances, so that the embodiments of this application can be implemented in an order other than the order illustrated or described herein. Objects classified by "first" and "second" are usually of a same type, and a quantity of objects is not limited. For example, there may be one or more first objects. In addition, "or" in this application represents at least one of connected objects. For example, "A or B" covers three solutions, that is, solution 1: including A and not including B; solution 2: including B and not including A; and solution 3: including A and B. The character "/" generally indicates an "or" relationship between associated objects.

The term "indication" in this application may be either a direct indication (or an explicit indication) or an indirect indication (or an implicit indication). A direct indication may be understood as: A transmitter explicitly notifies, in a transmitted indication, a receiver of content such as information, an operation that needs to be performed, or a request content. An indirect indication may be understood as: A receiver determines corresponding information based on an indication sent by a transmitter, or performs determining and determines, based on a determining result, an operation that needs to be performed, a request result, or the like.

Terms "at least one (item)" and "at least one" in this application refer to any one, any two, or a combination of more than two of the objects included in the term. For example, at least one (item) of a, b, and c may represent "a", "b", "c", "a and b", "a and c", "b and c", and "a, b, and c", where a, b, and c may be singular or plural. Similarly, "at least two (item)" means two or more, and a meaning thereof is similar to that of "at least one (item)".

It should be noted that technologies described in the embodiments of this application are not limited to a Long Term Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), single-carrier frequency division multiple access (SC-FDMA), or other systems. The terms "system" and "network" in the embodiments of this application may be used interchangeably. The technologies described can be applied to both the systems and the radio technologies mentioned above as well as to other systems and radio technologies. A new radio (NR) system is described in the following description for illustrative purposes, and NR terms are used in most of the following description, although these technologies can also be applied to communication systems other than the NR system application, such as the 6-th generation (6G) communication system.

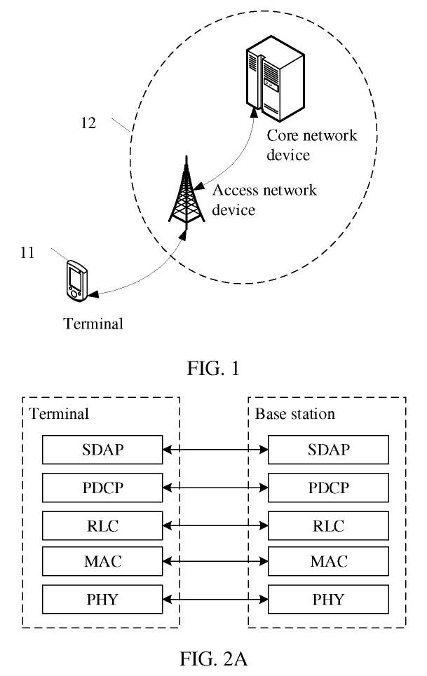

FIG. 1 is a block diagram of a wireless communication system to which the embodiments of this application may be applied. The wireless communication system includes a terminal 11 and a network side device 12. The terminal 11 may be a terminal side device such as a mobile phone, a tablet personal computer, a laptop computer, a notebook computer, a personal digital assistant (PDA), a palmtop computer, a netbook, an ultra-mobile personal computer (UMPC), a mobile Internet device (MID), an augmented reality (AR) device, a virtual reality (VR) device, a robot, a wearable device, a flight vehicle, vehicle user equipment (VUE), ship-borne equipment, pedestrian user equipment (PUE), a smart home device (a home device with a wireless communication function, such as a refrigerator, a television, a washing machine, or furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet bracelet, a smart anklet chain, or the like), a smart wrist strap, a smart dress, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a type of the terminal 11 is not limited in the embodiments of this application. The network side device 12 may include an access network device or a core network device. The access network device may also be referred to as a radio access network (RAN) device, a radio access network function, or a radio access network unit. The access network device may include a base station, a wireless local area network (WLAN) access point (AS), a wireless fidelity (Wi-Fi) node, and the like. The base station may be referred to as a NodeB (NB), an evolved NodeB (eNB), a next-generation NodeB (gNB), a new radio NodeB (NR NodeB), an access point, a relay base station (RBS), a serving base station (SBS), a base transceiver station (BTS), a radio base station, a radio transceiver, a basic service set (BSS), an extended service set (ESS), a home NodeB (HNB), a home evolved NodeB, a transmission reception point (TRP), or another suitable term in the field, provided that the same technical effect is achieved, and the base station is not limited to a specific technical vocabulary. It should be noted that only a base station in an NR system is used as an example in this embodiment of this application for description, and a type of the base station is not limited.

The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF) unit, an edge application service discovery function (EASDF), unified data management (UDM), unified data repository (UDR), a home subscriber server (HSS), centralized network configuration (CNC), a network repository function (NRF), a network exposure function (NEF), a local NEF (L-NEF), a binding support function (BSF), an application function (AF), or the like. It should be noted that, in the embodiments of this application, only a core network device in an NR system is used as an example for description, and a type of the core network device is not limited.

Some concepts and/or terms in an information obtaining method and apparatus, a device, and a non-transitory storage medium provided in the embodiments of this application are explained and described below.

### 1. XR extended reality

XR refers to all real-and-virtual combined environments and human-machine interactions generated by using a computer technology and a wearable device. XR includes representative forms such as augmented reality (AR), mixed reality (MR), and virtual reality (VR), and a cross field between them. Levels of the virtual world range from partial sensory input to fully immersive virtual reality. A key of XR is expansion of human experience, especially experience related to sense of presence (represented by VR) and cognitive acquisition (represented by AR).

For a VR service, relatively dense small data packets are mainly transmitted on an uplink. The small data packets may carry information such as a gesture and control, and serve as input and reference for downlink presentation data. On a downlink, multimedia data such as video and audio are mainly transmitted. Through timely receiving and presentation of the multimedia data, immersive experience is provided to a user. Downlink video data is used as an example. Data packets arrive periodically or quasi-periodically, with data rates reaching tens or even hundreds of Mbps. A typical value of a frame rate (FPS) is 60 or 120, and an interval between adjacent data packets is approximately 1/FPS seconds. Over an air interface, such data generally needs to be successfully transmitted within 10 ms, with a required transmission success rate of no less than 99 % or even 99.9 %.

For an AR service, in addition to the foregoing transmission of dense small data packets, on an uplink, multimedia data such as video and audio may also be transmitted. A service characteristic of the AR service is similar to that of the downlink. Generally, a data rate is relatively low, for example, a maximum of dozens of Mbps, and a time limit of air interface transmission may also be relaxed. For example, transmission generally needs to be performed successfully within 60 ms. Data transmission characteristics of the downlink are basically the same as those of the VR service.

In an application scenario of XR, in virtual reality experience, a user may obtain information of a new angle of view by performing actions such as turning the head. In this case, the head-turning action of the XR user may be notified to a base station by sending an uplink signal. After receiving the uplink signal, the base station schedules required downlink data for the XR user for use.

An XR service mainly includes video data, audio data, and some control signaling and special data that have a control function. In a wireless network, XR service transmission mainly relates to uplink and downlink video/audio data transmission and interaction between a terminal and a wireless network through a new network (such as LTE/NR). When transmitting video and audio data, the terminal needs to transmit, in an uplink, some control signaling and special data that have a control function by using a wireless network, for generation, processing, and downlink wireless transmission of video and audio service data in an XR service sent by a control network to the terminal.

These control information and special data having a control function include some service control data and control data information included in a service transmission protocol generated by a terminal XR application encoder, for example:
from a perspective of an application layer, the control information and special data may include (but are not limited to):
   an I-frame or a non-field of view (Field of View, FOV) frame generated by a video encoder; and
   user behavior data collected by a sensor, where the network may determine user behavior by receiving the data, for example, an action such as the foregoing rotation of the head of the user, so as to adjust transmitted video data content.

For a perspective of a transmission protocol layer, the control information and special data may include:
transmission control protocol (TCP) acknowledgement (ACK) signaling (that is, TCP feedback) for downlink audio/video service transmission, where a network needs to determine, based on whether a corresponding video/audio frame has been acknowledged by the UE, whether a subsequent frame can continue to be sent; and
real-time transmission control protocol (Real-time Control Protocol, RTCP) ACK signaling, which is control signaling used to control real-time data transmission, and acknowledge a real-time requirement of service data transmission and time synchronization.

A network usually needs to receive, in a timely and reliable manner, control signaling and special data having the control function from the terminal, to obtain a current transmission status of a service as well as related necessary control information. Based on this information, an application server generates video and audio service data that subsequently needs to be transmitted and delivers the video and audio service data to a wireless network for processing and transmission, which then sends the service data to the terminal over a downlink.

### 2. Packet data convergence protocol (PDCP) layer and radio bearer

Service data generated by an application (APP) layer of the terminal is classified into different service data streams based on corresponding quality of service (QoS) requirements, and each service data stream corresponds to a same QoS requirement or similar QoS requirements. In an NR system, the service data stream corresponds to one QoS flow, and in an LTE system, the service data stream corresponds to one evolved packet system (EPS) bearer.

Service data is delivered to an access stratum (AS) layer in a form of a data packet, and is mapped, at the AS, to a radio bearer based on a QoS flow (NR) or an EPS bearer (LTE) corresponding to the data packet. One radio bearer includes one PDCP entity (PDCP protocol layer processing entity), one radio link control (RLC) entity (PDCP protocol layer processing entity), and a corresponding logical channel (located at a medium access control (MAC) protocol layer).

After a data packet delivered to the AS is mapped to a radio bearer, the data packet is delivered to a corresponding PDCP entity in a form of a PDCP service data unit (SDU) for processing. The PDCP entity generates a corresponding PDCP protocol data unit (PDU) for each arrived PDCP SDU, and sets a PDCP sequence number (SN) to indicate a transmission ranking corresponding to each PDCP SDU and a corresponding PDCP PDU in the PDCP entity. A value of the PDCP SN is set based on an order in which the PDCP SDU is delivered to the PDCP entity, and a PDCP SDU that arrives first is transmitted before a PDCP SDU that is delivered later. For example, the PDCP entity maintains an internal variable TX_NEXT, which represents a total quantity of PDCP PDUs transmitted by the PDCP entity, and is used to set the value of the PDCP SN. When the PDCP entity is established, the PDCP entity initializes the internal variable to 0. Each time a PDCP SDU is delivered from an upper layer to a corresponding PDCP entity, the PDCP entity actually sets an SN of a PDCP PDU corresponding to the PDCP SDU to TX_NEXT, and increases TX NEXT by 1. Then, the PDCP entity adds a header file to each PDCP SDU to generate a corresponding PDCP PDU, where the PDCP PDU includes an SN value that is set for the PDCP PDU. The PDCP entity generally delivers PDCP PDUs in sequence to a lower protocol layer (an RLC layer) for subsequent processing and transmission based on a sequence of SNs included in the PDCP PDU. The SN is a sequence number, indicating a transmission ranking of each PDCP SDU.

A general principle is that a PDCP SDU that arrives at the PDCP entity earlier leads to a smaller SN value and earlier transmission.

### 3. Network architecture and air interface protocol stack

A network system includes an access network and a core network. There are two types of access networks: a gNB, which provides NR user plane and control plane protocol termination points for the terminal; and ng-eNB, which provides a terminal with user plane and control plane protocol termination points of an evolved universal mobile telecommunications system (UMTS) terrestrial radio access (E-UTRA).

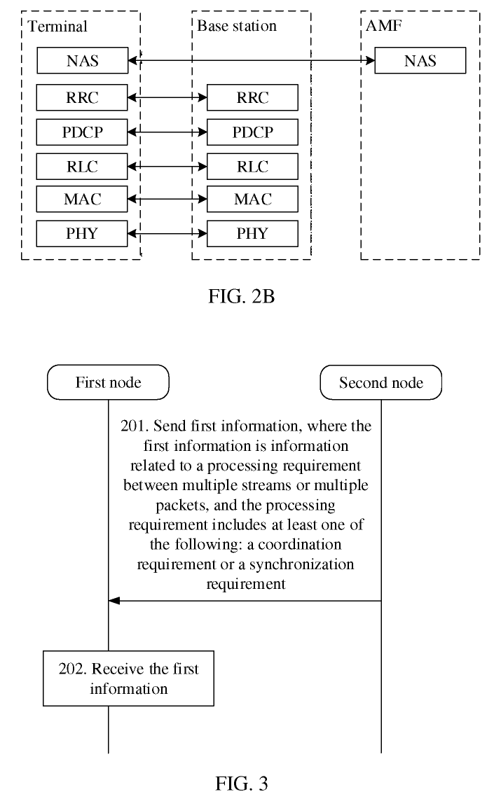

As shown in FIG. 2A, a user plane protocol stack of a terminal and a base station (gNB) includes a service data adaptation protocol (SDAP) layer, a PDCP layer, an RLC layer, a MAC layer, and a physical (PHY) layer.

As shown in FIG. 2B, a control plane protocol stack of a terminal includes a non-access stratum (NAS) layer, a radio resource control (RRC) layer, a PDCP layer, an RLC layer, a MAC layer, and a PHY layer; a control plane protocol stack of a gNB includes an RRC layer, a PDCP layer, an RLC layer, a MAC layer, and a PHY layer; and a control plane protocol stack of a core network (for example, an AMF network element) includes NAS.

An information obtaining method provided in the embodiments of this application is described in detail below with reference to the accompanying drawings by using embodiments and application scenarios thereof.

The embodiments of this application may be applied to a scenario in which there is a multi-stream service, such as an XR service or a CG service.

Currently, QoS requirements and operations between streams or packets are independent, and coordination and synchronization between multiple streams or packets are not defined. Consequently, effective per-stream or per-packet coordination and synchronization processing cannot be performed.

To resolve the foregoing problem, an embodiment of this application provides an information obtaining method. A first node may receive first information from a second node, that is, information related to a processing requirement between multiple streams or multiple packets. The processing requirement includes at least one of a coordination requirement or a synchronization requirement to obtain a coordination requirement, a synchronization requirement, or the like between streams. Therefore, the first node can define coordination and synchronization between multiple streams based on the information related to the processing requirement between multiple streams or multiple packets, so as to perform effective per-stream or per-packet coordination and synchronization processing to satisfy the processing requirement between multiple streams or multiple packets.

An information obtaining method is provided in an embodiment of this application. FIG. 3 is a flowchart of an information obtaining method according to an embodiment of this application. As shown in FIG. 3, the information obtaining method provided in this embodiment of this application may include the following step 201 and step 202.

Step 201: A second node sends first information to a first node.

Step 202: The first node receives the first information from the second node.

In this embodiment of this application, the first information is information related to a processing requirement between multiple streams or multiple packets, and the processing requirement includes at least one of the following: a coordination requirement or a synchronization requirement.

In this embodiment of this application, the first node and the second node are different nodes, or the first node and the second node are different protocol layers in a same node.

Optionally, in this embodiment of this application, the multiple streams may be multiple streams of a same service, or may be multiple streams of different services. The service may be a multi-stream service, such as an XR service or a CG service.

Optionally, in this embodiment of this application, the multiple packets may be multiple packets of a same service, or may be multiple packets of different services. The service may be a multi-packet service, such as an XR service or a CG service.

Optionally, in this embodiment of this application, the first information may include at least one of the following: synchronization requirement information, coordination requirement information, processing object information, an uplink indication, a downlink indication, a processing mark, a time tag, a processing association relationship, or an indication of whether the processing requirement is satisfied.

The processing object information is information about an object having the processing requirement. The uplink indication is used to indicate an uplink processing requirement. The downlink indication is used to indicate a downlink processing requirement. The processing mark is used to indicate that a first stream or a first packet has the processing requirement. The time tag is used to indicate time information corresponding to a second stream or a second packet. The processing association relationship is used to indicate an association relationship between packets or streams having the processing requirement.

It should be noted that the time tag may alternatively be a timestamp. The association relationship refers to an association relationship between packets or streams, for example, a coordination association relationship or a synchronization association relationship.

Optionally, in this embodiment of this application, the synchronization requirement information is used to indicate that there is a synchronization requirement between the multiple streams or the multiple packets.

Optionally, in this embodiment of this application, the coordination requirement information is used to indicate that there is a coordination requirement between the multiple streams or the multiple packets.

It should be noted that the synchronization requirement information may be a value indicating the synchronization requirement, and the coordination requirement information may be a value indicating the coordination requirement.

Optionally, in this embodiment of this application, the processing object information may include at least one of synchronization object information or coordination object information. A processing object may include an object having at least one of the synchronization requirement, the coordination requirement, or an association requirement.

Optionally, in this embodiment of this application, the information about the object having the processing requirement may include at least one of the following:
an identifier of a terminal pair or a terminal group;
an identifier of a stream pair or a stream group;
an identifier of a QoS flow pair or a QoS flow group;
an identifier of a data radio bearer (DRB) pair or a DRB group;
an identifier of a bearer pair or a bearer group;
an identifier of a PDU session pair or a PDU session group; or
an identifier of a service pair or a service group.

Optionally, in this embodiment of this application, the terminal pair or the terminal group includes at least one of the following:
a terminal having the processing requirement;
a terminal on which a stream having the processing requirement is located;
a terminal on which a QoS flow having the processing requirement is located;
a terminal on which a DRB having the processing requirement is located;
a terminal on which a bearer having the processing requirement is located;
a terminal on which a PDU session having the processing requirement is located; or
a terminal on which a service having the processing requirement is located.

Optionally, in this embodiment of this application, the bearer may include at least one of the following: a signaling radio bearer (SRB) or a DRB.

It should be noted that the pair or group means two or more. For example, the identifier of the stream pair or the stream group means two or more stream identifiers.

Optionally, in this embodiment of this application, the stream pair or stream group may include a steam having at least one of the synchronization requirement or the coordination requirement.

Optionally, in this embodiment of this application, the QoS flow pair or the QoS flow group may include a QoS flow having at least one of the synchronization requirement or the coordination requirement.

Optionally, in this embodiment of this application, the DRB pair or the DRB group may include a DRB having at least one of the synchronization requirement or the coordination requirement.

Optionally, in this embodiment of this application, the bearer pair or the bearer group may include a bearer having at least one of the synchronization requirement or the coordination requirement.

Optionally, in this embodiment of this application, the PDU session pair or the PDU session group may include a PDU session having at least one of the synchronization requirement or the coordination requirement.

Optionally, in this embodiment of this application, the service pair or the service group may include a service having at least one of the synchronization requirement or the coordination requirement.

Optionally, in this embodiment of this application, the uplink indication may be used to indicate at least one of an uplink synchronization requirement or an uplink coordination requirement.

Optionally, in this embodiment of this application, the downlink indication may be used to indicate at least one of a downlink synchronization requirement or a downlink coordination requirement.

Optionally, in this embodiment of this application, the processing mark may include at least one of a synchronization mark or a coordination mark. The synchronization mark is used to indicate that the first stream or the first packet has the synchronization requirement, and the coordination mark is used to indicate that the first stream or the first packet has the coordination requirement.

Optionally, in this embodiment of this application, the first stream may include at least one of the following: a stream including the processing mark, a stream associated with the processing mark, or a stream associated with a stream or a packet including the processing mark.

Optionally, in this embodiment of this application, the first packet may include at least one of the following: a packet including the processing mark, a packet associated with the processing mark, or a packet associated with a packet or a stream including the processing mark.

Optionally, the "packet" in this embodiment of this application may include at least two packets in a same second object or different second objects. The second object includes at least one of the following: an associated user equipment group, user equipment (UE), a stream, a QoS flow, an Internet protocol (IP) layer or a user datagram protocol (UDP) layer, a burst, a bearer, a PDU session, a PDU set, a PDU, a DRB, or a service.

It should be noted that the associated user equipment groups may be understood as multiple devices of a same user, multiple associated devices (Tethered UE), multiple devices used by a same user, or multiple devices that carry a same type of service. For example, these devices may include a mobile phone, a watch, smart gloves, a head-mounted display, a helmet, a headset, a vehicle-mounted device, and the like.

The PDU set in this embodiment of this application includes one or more PDUs, and the PDU is carried in payload of an information unit generated at an application level. In some implementations, an application layer requires all PDUs in the PDU set to use a corresponding information unit. In other implementations, when some PDUs are missing, the application layer may still restore some or all of the information units. In other words, a definition of the PDU set in a protocol is: A PDU Set is composed of one or more PDUs carrying the payload of one unit of information generated at the application level. In some implementations all PDUs in a PDU Set are needed by the application layer to use the corresponding unit of information. In other implementations, the application layer can still recover parts or all of the information unit, and when some PDUs are missing.

The burst in this embodiment of this application may be understood as a data burst, that is, data generated in a short time by an application program, including PDUs from one or more PDU sets. In other words, a definition of the Data burst in a protocol is: Data produced by the application in a short period of time, comprising PDUs from one or more PDU Sets.

Optionally, the "packet" in this embodiment of this application may include at least one of the following:
at least two packets of a same user;
at least two packets of different users;
at least two packets of same UE;
at least two packets of different UEs;
at least two packets of a same stream;
at least two packets of different streams;
at least two packets of a same QoS flow;
at least two packets of different QoS flows;
at least two packets in a same IP/UDP packet;
at least two packets in different IP/UDP packets;
at least two packets in a same burst;
at least two packets in different bursts;
at least two packets in a same bearer;
at least two packets in different bearers;
at least two packets in a same PDU session;
at least two packets in different PDU sessions;
at least two packets in a same PDU set;
at least two packets in different PDU sets;
at least two packets in a same PDU;
at least two packets in different PDUs;
at least two packets in a same DRB;
at least two packets in different DRBs;
at least two packets in a same service; or
at least two packets in different services.

Optionally, in this embodiment of this application, the different users may include different users in a same base station, a same cell, a same distributed unit (DU), a same centralized unit (CU), a same core network, a same RAN, a same public land mobile network (PLMN), or a same network.

Optionally, in this embodiment of this application, the different users may include different users in different base stations, different cells, different DUs, different CUs, different core networks, different RANs, different PLMNs, or different networks.

Optionally, in this embodiment of this application, the different UEs may include different UEs of a same user (for example, different devices of a same user, including a watch, gloves, a head-mounted display, a helmet, glasses, a mobile phone, and an AR/VR device). Alternatively, the different UEs may include different UEs of different users.

Optionally, in this embodiment of this application, the different streams may include different streams of a same UE or different streams of different UEs.

Optionally, in this embodiment of this application, the different QoS flows may include different QoS flows of the same UE or different QoS flows of different UEs.

Optionally, in this embodiment of this application, the different QoS flows may include different QoS flows of the same stream or different QoS flows of different streams.

Optionally, in this embodiment of this application, the different IP/UDP packets may include different IP/UDP packets of the same UE, different IP/UDP packets of the same stream, different IP/UDP packets of different UEs, or different IP/UDP packets of different streams.

Optionally, in this embodiment of this application, the different bursts may include different bursts of a same stream, different bursts of a same IP/UDP packet, different bursts of a same QoS flow, different bursts of different streams, different bursts of different IP/UDP packets, or different bursts of different QoS flows.

Optionally, in this embodiment of this application, the different PDU sets may include different PDU sets of the same stream, different PDU sets of the same IP/UDP packet, different PDU sets of the same QoS flow, different PDU sets of different streams, different PDU sets of different IP/UDP packets, or different PDU sets of different QoS flows.

Optionally, in this embodiment of this application, the different DBRs may include different DBRs of the same stream, different DBRs of the same IP/UDP packet, different DBRs of the same QoS flow, different DBRs of different streams, different DBRs of different IP/UDP packets, or different DBRs of different QoS flows.

Optionally, the "packet" in this embodiment of this application refers to at least one of the following: a packet, a burst, a PDU set, a PDU, an SDU, a DRB, a transport block (TB), or the like.

Optionally, in this embodiment of this application, the packet refers to at least one of the following: a burst, a PDU set, a PDU, an SDU, a DRB, or a TB.

For example, one packet includes multiple bursts, one burst includes multiple PDU sets, and one PDU set includes multiple PDUs.

Optionally, in this embodiment of this application, the time tag is used to indicate at least one of the following time information:
information about time at which a first object arrives at the first node;
information about time at which the first object leaves the first node;
a processing delay of the first object at the first node; or
a remaining delay requirement of the first object; where
the first object includes at least one of the following:
   a stream, a QoS flow, a DRB, a bearer, a PDU session, a service, or a packet.

Optionally, in this embodiment of this application, the second stream may include at least one of the following: a stream including the time tag, a stream associated with the time tag, or a stream associated with a stream or a packet including the time tag.

Optionally, in this embodiment of this application, the second packet may include at least one of the following: a packet including the time tag, a packet associated with the time tag, or a packet associated with a packet or a stream including the time tag.

For example, it is assumed that a total delay requirement of the packet is X, and a delay before the second node is Y, and in this case, a remaining delay requirement is X−Y.

Optionally, in this embodiment of this application, the processing association relationship may include at least one of a synchronization association relationship or a coordination association relationship. The synchronization association relationship is used to indicate an association relationship between packets or streams having the synchronization requirement, and the coordination association relationship is used to indicate an association relationship between packets or streams having the coordination requirement.

Optionally, in this embodiment of this application, the indication of whether the processing requirement is satisfied may include an indication of whether the processing requirement is satisfied between processing objects. For example, the indication may include at least one of the following: whether a synchronization object satisfies the synchronization requirement, whether a coordination object satisfies the synchronization requirement, whether the synchronization object satisfies the coordination requirement, or whether the coordination object satisfies the coordination requirement.

It should be noted that the synchronization object may be understood as an object having the synchronization requirement, and the coordination object may be understood as an object having the coordination requirement.

Optionally, in this embodiment of this application, the information about the object having the processing requirement may include at least one of the following: an identifier of at least one terminal, an identifier of at least one stream, an identifier of at least one QoS flow, an identifier of at least one DRB, an identifier of at least one bearer, an identifier of at least one PDU session, an identifier of at least one service, identification information of at least one packet, identification information of at least one stream, type information of at least one packet, or type information of at least one stream.

Optionally, in this embodiment of this application, the identification information of the packet may include at least one of the following: an identifier of the packet, an index of the packet, a serial number (SN) of the packet, or the like.

Optionally, in this embodiment of this application, the identification information of the stream may include at least one of the following: an identifier of the stream, an index of the stream, an SN of the stream, or the like.

Optionally, in this embodiment of this application, the type information of the stream may include at least one of the following: a QoS flow type, a stream type, or the like.

For example, if the first information includes two QoS flow identifiers and one UE identifier, it means that two QoS flows (QoS flows corresponding to the two QoS flow identifiers) of one UE (UE corresponding to the UE identifier) has at least one of the synchronization requirement or the coordination requirement.

For another example, if the first information includes two QoS flow identifiers and one stream identifier, it means that two QoS flows (QoS flows corresponding to the two QoS flow identifiers) of one steam (a stream corresponding to the stream identifier) has at least one of the synchronization requirement or the coordination requirement.

For another example, if the first information includes two UE identifiers and one stream identifier, it means that a stream (a stream corresponding to the stream identifier) of two UEs (UEs corresponding to the two UE identifiers) has at least one of the synchronization requirement or the coordination requirement.

Optionally, in this embodiment of this application, the first node and the second node are different nodes.

The first node is a base station, and the second node is a terminal; or
the first node is a core network node, and the second node is a base station or a terminal; or
the first node is a server, and the second node is a core network node or a terminal; or
the first node is a terminal, and the second node is any one of the following:
   a base station, a core network node, and a server.

Optionally, in this embodiment of this application, the first node and the second node are different protocol layers in a same node, the first node is a first protocol layer, and the second node is a second protocol layer.

The first protocol layer is any one of the following:
an IP layer, a TCP layer, and a UDP layer, and the second protocol layer is an SDAP layer; or
the first protocol layer is an SDAP layer, and the second protocol layer is a PDCP layer; or
the first protocol layer is a PDCP layer, and the second protocol layer is an RLC layer; or
the first protocol layer is an RLC layer, and the second protocol layer is a MAC layer; or the first protocol layer is a MAC layer, and the second protocol layer is a PHY layer.

Optionally, in this embodiment of this application, the same node may be a base station, a core network node, a server, a terminal, or the like.

Optionally, in this embodiment of this application, the first information is carried in a user plane message. Alternatively, the first information is carried in a control plane message. Alternatively, a first portion of information in the first information is carried in a control plane message, and a second portion of information in the first information is carried in a user plane message.

Optionally, in this embodiment of this application, the first information is carried in a user plane message, and the first information includes at least one of the following: synchronization requirement information, coordination requirement information, processing object information, a processing mark, a time tag, a processing association relationship, or an indication of whether the processing requirement is satisfied.

In a case that the first node receives the first information, an object in which the first information is located or with which the first information is associated has the processing requirement, that is, at least one of the synchronization requirement or the coordination requirement.

Optionally, in this embodiment of this application, the first information includes at least one of the following: processing object information, a processing mark, a time tag, a processing association relationship, or an indication of whether the processing requirement is satisfied. The processing requirement is satisfied by satisfying a delay requirement of the first object. The first object includes at least one of the following: a stream, a QoS flow, a DRB, a bearer, a PDU session, a service, or a packet, and the delay requirement includes at least one of the following: a PDU set delay budget (PSDB) requirement, a packet delay budget (PDB) requirement, or a transmission delay requirement.

It should be noted that satisfying the processing requirement may be understood as requiring to satisfy the delay requirement of the first object.

Optionally, in this embodiment of this application, in a case that the object in which the first information is located or with which the first information is associated satisfies the delay requirement of the first object, the object in which the first information is located or with which the first information is associated satisfies the processing requirement, that is, satisfies at least one of the synchronization requirement or the coordination requirement.

Optionally, in this embodiment of this application, in a case that the object in which the first information is located or with which the first information is associated does not satisfy the delay requirement of the first object, the object in which the first information is located or with which the first information is associated does not satisfy the processing requirement, that is, does not satisfy the synchronization requirement or the coordination requirement.

Optionally, in this embodiment of this application, in a case that the first node does not receive the first information, it is determined that the object in which the first information is located or with which the first information is associated has no processing requirement, that is, has no synchronization requirement and no coordination requirement.

Optionally, in this embodiment of this application, the first portion of information in the first information is carried in a control plane message, and the second portion of information in the first information is carried in a user plane message. The first portion of information includes at least one of the following: a processing mark, a processing association relationship, or an indication of whether the processing requirement is satisfied. The second portion of information includes at least one of the following: synchronization requirement information, coordination requirement information, processing object information, or a time tag.

In a case that the first node receives the first portion of information, the object in which the first information is located or with which the first information is associated has the processing requirement, that is, has at least one of the synchronization requirement or the coordination requirement.

Optionally, in this embodiment of this application, in a case that the first node receives the first portion of information and does not receive the second portion of information, the processing requirement is satisfied by satisfying the delay requirement of the first object. The first object includes at least one of the following: a stream, a QoS flow, a DRB, a bearer, a PDU session, a service, or a packet, and the delay requirement includes at least one of the following: a PSDB requirement, a PDB requirement, or a transmission delay requirement.

Optionally, in this embodiment of this application, in a case that the first node receives the first portion of information and the received second portion of information includes the synchronization requirement information and the coordination requirement information, the processing requirement is the synchronization requirement or the coordination requirement.

It should be noted that the synchronization requirement herein is a synchronization requirement corresponding to the synchronization requirement information in the second portion of information, that is, a value corresponding to the synchronization requirement, and the coordination requirement herein is a coordination requirement corresponding to the coordination requirement information in the second portion of information, that is, a value corresponding to the coordination requirement.

Optionally, in this embodiment of this application, in a case that the first node receives the second portion of information in the first information, it is determined that the object in which the first information is located or with which the first information is associated has the processing requirement, that is, has at least one of the synchronization requirement or the coordination requirement.

Optionally, in this embodiment of this application, in a case that the first node does not receive the first portion of information in the first information, it is determined that the object in which the first information is located or with which the first information is associated has no processing requirement, that is, has no synchronization requirement and no coordination requirement.

Optionally, in this embodiment of this application, the user plane message may include at least one of the following:
a general packet radio service tunnel protocol-user plane (GTP-U) message or a GTP-U message header;
a PDU set message or a PDU set message header;
a PDU message or a PDU message header;
an SDAP PDU message header;
a PDCP PDU message header;
an RLC PDU message header; or
a MAC control element (CE) message.

Optionally, in this embodiment of this application, the first information is carried in a control plane message, and the first information includes at least one of the following: synchronization requirement information, coordination requirement information, processing object information, a processing mark, a processing association relationship, or an indication of whether the processing requirement is satisfied.

In a case that the first node receives the first information, the object in which the first information is located or with which the first information is associated has the processing requirement.

Optionally, in this embodiment of this application, the control plane message may include at least one of the following: a general packet radio service tunnel protocol-control plane (GTP-C) message or a GTP-C message header; an RRC message; or a NAS message.

Optionally, in this embodiment of this application, in a case that the first information is uplink information, the RRC message includes either of the following: a user equipment assistance information (UAI) message and a connection setup message.

Optionally, in this embodiment of this application, in a case that the first information is downlink information, the RRC message includes either of the following: an RRC configuration message and an RRC reconfiguration message.

Optionally, in this embodiment of this application, in a case that the first information is uplink information, the NAS message includes any one of the following: a service request message, a service accept message, and an identity request message.

Optionally, in this embodiment of this application, in a case that the first information is downlink information, the NAS message includes either of the following: a service response message and an identity response message.

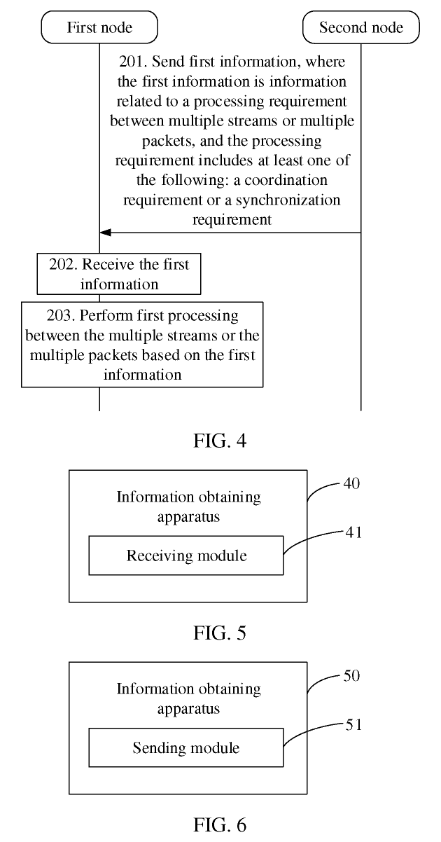

Optionally, in this embodiment of this application, in combination with FIG. 3, as shown in FIG. 4, after the step 202, the information obtaining method provided in this embodiment of this application further includes the following step 203.

Step 203: The first node performs first processing between multiple streams or multiple packets based on the first information.

In this embodiment of this application, the first processing includes at least one of the following: coordination processing or synchronization processing.

In this embodiment of this application, coordination processing is processing that satisfies the coordination requirement, and synchronization processing is processing that satisfies the synchronization requirement.

Satisfying the synchronization requirement per-packet or per-stream may be understood as at least one of the following: (1) keeping a specific synchronization relationship between multiple packets or multiple streams at a receiving end , that is, satisfying the synchronization requirement, for example, multiple packets or multiple streams are received close in time or at the same time at the receiving end; or (2) keeping a specific synchronization relationship between displaying and buffering of multiple packets or multiple streams in a display buffer at the receiving end , that is, satisfying the synchronization requirement or the coordination requirement, for example, multiple packets or multiple streams are displayed and buffered close in time or at the same time at the receiving end .

Satisfying the coordination requirement between multiple packets or multiple streams may be understood as at least one of the following: (1) multiple packets or multiple streams are received at the same time through coordination at the receiving end, or (2) multiple packets or multiple streams are coordinated at the receiving end to achieve display buffer times that are close to each other or simultaneous, thereby improving service experience of a user.

As an example, the coordination processing or the synchronization processing includes at least one of the following:
(1) mapping a stream to a corresponding quality of service flow (QoS flow);
for example, different streams or different packets satisfy the synchronization requirement or the coordination requirement through control of mapping a stream to the QoS flow;
(2) mapping a stream or a QoS flow to a corresponding data radio bearer (DRB);
for example, different streams or different packets satisfy the synchronization requirement or the coordination requirement through control of mapping the stream or the QoS flow to the DRB;
(3) mapping a stream, a QoS flow, or a DRB to a corresponding radio bearer;
for example, different streams or packets of different streams satisfy the synchronization requirement or the coordination requirement through control of mapping the stream, the QoS flow, or the DRB to the bearer;
(4) mapping a stream, a QoS flow, a DRB, or a bearer to a corresponding logical channel group (LCG);
for example, different streams or packets of different streams satisfy the synchronization requirement or the coordination requirement through control of mapping the stream, the QoS flow, the DRB, or the bearer to the LCG;
(5) mapping a stream, a QoS flow, a DRB, or a bearer to a corresponding logical channel priority (LCP);
for example, different streams or packets of different streams satisfy the synchronization requirement or the coordination requirement through control of mapping the stream, the QoS flow, the DRB, or the bearer to the LCP;
(6) mapping a stream, a QoS flow, a DRB, or a bearer to a corresponding logical channel (LCH);
for example, different streams or packets of different streams satisfy the synchronization requirement or the coordination requirement through control of mapping the stream, the QoS flow, the DRB, or the bearer to the LCH; or
(7) applying a corresponding discard timer;
for example, different streams or packets of different streams satisfy the synchronization requirement or the coordination requirement through control of setting different discardTimer for different packets or packets of different streams.

That the synchronization requirement is satisfied between packets means that a delay difference between multiple packets is less than or equal to a first preset threshold. That the synchronization requirement is satisfied between streams means that a delay difference between multiple streams is less than a second preset threshold.

Optionally, the delay difference includes one of the following: a latency, a delay gap, and a difference.

Optionally, the first preset threshold and the second preset threshold may be defined in a protocol, or may be configured by a server, a core network, a base station, an application layer, or the like.

In this embodiment of this application, the first information may be used by the first node to perform at least one of coordination processing or synchronization processing on multiple streams or multiple packets. In other words, the first node may perform at least one of coordination processing or synchronization processing on the multiple streams or the multiple packets based on the first information. In this way, the first node processes the multiple streams or the multiple packets, to ensure synchronization or coordination between multiple streams or multiple packets of a service, or to ensure that when multiple streams or multiple packets of a service are not synchronized or coordinated, the first node can perform processing on the corresponding streams or packets.

Optionally, in this embodiment of this application, the first node may perform coordination processing and synchronization processing on multiple streams or multiple packets of a service (for example, an XR service) based on the first information, to resolve a problem such as stuttering, dizziness, and inconsistency between video and/or audio caused by out-of-synchronization of the multiple streams or the multiple packets of the service.

An embodiment of this application provides an information obtaining method. A first node may receive first information from a second node, that is, information related to a processing requirement between multiple streams or multiple packets. The processing requirement includes at least one of a coordination requirement or a synchronization requirement to obtain a coordination requirement, a synchronization requirement, or the like between streams. Therefore, the first node can define coordination and synchronization between multiple streams based on the information related to the processing requirement between multiple streams or multiple packets, so as to perform effective per-stream or per-packet coordination and synchronization processing to satisfy the processing requirement between multiple streams or multiple packets.

It should be noted that in this application, both the first node and the second node can execute the technical solutions of this application, that is, a process performed by the first node can also be performed by the second node, and a related solution implemented by the first node can also be implemented by the second node. This embodiment of this application is merely described from a perspective of the first node. For an implementation process and a solution of the second node, reference may be made to all descriptions of the first node. Details are not described in the embodiments of this application.

The foregoing method embodiments or the possible implementations in the method embodiments may be separately performed, or any two or more of the method embodiments may be performed together, which may be determined based on an actual use requirement. This is not limited in the embodiments of this application.

The information obtaining method provided in the embodiments of this application may be performed by an information obtaining apparatus. In the embodiments of this application, that the information obtaining apparatus performs the information obtaining method is used as an example to describe the information obtaining apparatus provided in the embodiments of this application.

FIG. 5 is a possible schematic structural diagram of an information obtaining apparatus according to an embodiment of this application. The information obtaining apparatus may be applied to a first node. As shown in FIG. 5, an information obtaining apparatus 40 may include a receiving module 41.

The receiving module 41 is configured to receive first information from a second node, where the first information is information related to a processing requirement between multiple streams or multiple packets, and the processing requirement includes at least one of the following: a coordination requirement or a synchronization requirement. The first node and the second node are different nodes, or the first node and the second node are different protocol layers in a same node.

An embodiment of this application provides an information obtaining apparatus. The information obtaining apparatus may receive first information from a second node, that is, information related to a processing requirement between multiple streams or multiple packets. The processing requirement includes at least one of a coordination requirement or a synchronization requirement to obtain a coordination requirement, a synchronization requirement, or the like between streams. Therefore, the first node can define coordination and synchronization between multiple streams based on the information related to the processing requirement between multiple streams or multiple packets, so as to perform effective per-stream or per-packet coordination and synchronization processing to satisfy the processing requirement between multiple streams or multiple packets.

In a possible implementation, the first information includes at least one of the following: synchronization requirement information, coordination requirement information, processing object information, an uplink indication, a downlink indication, a processing mark, a time tag, a processing association relationship, or an indication of whether the processing requirement is satisfied.

The processing object information is information about an object having the processing requirement; the uplink indication is used to indicate an uplink processing requirement, and the downlink indication is used to indicate a downlink processing requirement; the processing mark is used to indicate that a first stream or a first packet has the processing requirement; the time tag is used to indicate time information corresponding to second stream or a second packet; and the processing association relationship is used to indicate an association relationship between packets or streams having the processing requirement.

In a possible implementation, the information about the object having the processing requirement includes at least one of the following:
an identifier of a terminal pair or a terminal group;
an identifier of a stream pair or a stream group;
an identifier of a QoS flow pair or a QoS flow group;
an identifier of a DRB pair or a DRB group;
an identifier of a bearer pair or a bearer group;
an identifier of a PDU session pair or a PDU session group; or
an identifier of a service pair or a service group.

In a possible implementation, the terminal pair or the terminal group includes at least one of the following:
a terminal having the processing requirement;
a terminal on which a stream having the processing requirement is located;
a terminal on which a QoS flow having the processing requirement is located;
a terminal on which a DRB having the processing requirement is located;
a terminal on which a bearer having the processing requirement is located;
a terminal on which a PDU session having the processing requirement is located; or
a terminal on which a service having the processing requirement is located.

In a possible implementation, the information about the object having the processing requirement includes at least one of the following:an identifier of at least one terminal, an identifier of at least one stream, an identifier of at least one QoS flow, an identifier of at least one DRB, an identifier of at least one bearer, an identifier of at least one PDU session, an identifier of at least one service, identification information of at least one packet, identification information of at least one stream, type information of at least one packet, or type information of at least one stream.

In a possible implementation, the first stream includes at least one of the following:
a stream including the processing mark, a stream associated with the processing mark, or a stream associated with a stream or a packet including the processing mark; and
the first packet includes at least one of the following:
   a packet including the processing mark, a packet associated with the processing mark, or a packet associated with a packet or a stream including the processing mark.

In a possible implementation, the time tag is used to indicate at least one of the following time information:
information about time at which a first object arrives at the first node;
information about time at which the first object leaves the first node;
a processing delay of the first object at the first node; or
a remaining delay requirement of the first object; where
the first object includes at least one of the following:
   a stream, a QoS flow, a DRB, a bearer, a PDU session, a service, or a packet.

In a possible implementation, the second stream includes at least one of the following:
a stream including the time tag, a stream associated with the time tag, or
a stream associated with a stream or a packet including the time tag; and
the second packet includes at least one of the following:
   a packet including the time tag, a packet associated with the time tag, or a packet associated with a packet or a stream including the time tag.

In a possible implementation, the first node and the second node are different nodes; and
the first node is a base station, and the second node is a terminal; or
the first node is a core network node, and the second node is a base station or a terminal; or
the first node is a server, and the second node is a core network node or a terminal; or
the first node is a terminal, and the second node is any one of the following: a base station, a core network node, and a server.

In a possible implementation, the first node and the second node are different protocol layers in a same node, the first node is a first protocol layer, and the second node is a second protocol layer; and
the first protocol layer is any one of the following: an IP layer, a TCP layer, and a UDP layer, and the second protocol layer is an SDAP layer; or
the first protocol layer is an SDAP layer, and the second protocol layer is a PDCP layer; or
the first protocol layer is a PDCP layer, and the second protocol layer is an RLC layer; or
the first protocol layer is an RLC layer, and the second protocol layer is a MAC layer; or
the first protocol layer is a MAC layer, and the second protocol layer is a PHY layer.

In a possible implementation, the first information is carried in a user plane message; or
the first information is carried in a control plane message; or
a first portion of information in the first information is carried in a control plane message, and a second portion of information in the first information is carried in a user plane message.

In a possible implementation, the first information is carried in a user plane message, and the first information includes at least one of the following: synchronization requirement information, coordination requirement information, processing object information, a processing mark, a time tag, a processing association relationship, or an indication of whether the processing requirement is satisfied.

In a case that the first node receives the first information, the object in which the first information is located or with which the first information is associated has the processing requirement.

In a possible implementation, the first information includes at least one of the following: processing object information, a processing mark, a time tag, a processing association relationship, or an indication of whether the processing requirement is satisfied.

The processing requirement is satisfied by satisfying a delay requirement of the first object, the first object includes at least one of the following: a stream, a QoS flow, a DRB, a bearer, a PDU session, a service, and a packet, and the delay requirement includes at least one of the following: a PSDB requirement, a PDB requirement, or a transmission delay requirement.

In a possible implementation, the first portion of information in the first information is carried in a control plane message, and the second portion of information in the first information is carried in a user plane message.

The first portion of information includes at least one of the following: a processing mark, a processing association relationship, or an indication of whether the processing requirement is satisfied. The second portion of information includes at least one of the following: synchronization requirement information, coordination requirement information, processing object information, or a time tag.

In a case that the first node receives the first portion of information, the object in which the first information is located or with which the first information is associated has the processing requirement.

In a possible implementation, in a case that the first node receives the first portion of information and does not receive the second portion of information, the processing requirement is satisfied by satisfying the delay requirement of the first object. The first object includes at least one of the following: a stream, a QoS flow, a DRB, a bearer, a PDU session, a service, or a packet, and the delay requirement includes at least one of the following: a PSDB requirement, a PDB requirement, or a transmission delay requirement.

In a possible implementation, in a case that the first node receives the first portion of information and the received second portion of information includes synchronization requirement information and coordination requirement information, the processing requirement is the synchronization requirement or the coordination requirement.

In a possible implementation, the user plane message includes at least one of the following:
a GTP-U message or a GTP-U message header;
a PDU set message or a PDU set message header;
a PDU message or a PDU message header;
an SDAP PDU message header;
a PDCP PDU message header;
an RLC PDU message header; or
a MAC CE message.

In a possible implementation, the first information is carried in a control plane message, and the first information includes at least one of the following:synchronization requirement information, coordination requirement information, processing object information, a processing mark, a processing association relationship, or an indication of whether the processing requirement is satisfied.

In a case that the first node receives the first information, the object in which the first information is located or with which the first information is associated has the processing requirement.

In a possible implementation, the control plane message includes at least one of the following:
a GTP-C message or a GTP-C message header;
an RRC message; or
a NAS message.

In a possible implementation, in a case that the first information is uplink information, the RRC message includes either of the following:
a UAI message and a connection setup message;
or
in a case that the first information is downlink information, the RRC message includes either of the following:
   an RRC configuration message and an RRC reconfiguration message.

In a possible implementation, in a case that the first information is uplink information, the NAS message includes any one of the following:
a service request message, a service accept message, and an identity request message;
or
in a case that the first information is downlink information, the NAS message includes either of the following:
   a service response message and an identity response message.

In a possible implementation, the packet includes at least two packets in a same second object or different second objects, and the second object includes at least one of the following: an associated user equipment group, user equipment, a stream, a QoS flow, an IP layer or a UDP layer, a burst, a bearer, a PDU session, a PDU set, a PDU, a DRB, or a service.

In a possible implementation, the information obtaining apparatus 40 provided in this embodiment of this application may further include an execution module. The execution module is configured to: after the receiving module 41 receives the first information from the second node, perform first processing between multiple streams or multiple packets based on the first information, where the first processing includes at least one of the following: coordination processing or synchronization processing.

The information obtaining apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a network attached storage (NAS), or the like. This is not limited in this embodiment of this application.

The information obtaining apparatus provided in this embodiment of this application can implement the processes implemented in the foregoing embodiments of the information obtaining method, and achieve the same technical effect. To avoid repetition, details are not described herein again.

FIG. 6 is a possible schematic structural diagram of an information obtaining apparatus according to an embodiment of this application. The information obtaining apparatus may be applied to a second node. As shown in FIG. 6, an information reporting apparatus 50 may include a sending module 51.

The sending module 51 is configured to send first information to a first node, where the first information is information related to a processing requirement between multiple streams or multiple packets, and the processing requirement includes at least one of the following: a coordination requirement or a synchronization requirement. The first node and the second node are different nodes, or the first node and the second node are different protocol layers in a same node.

An embodiment of this application provides an information obtaining apparatus. The information obtaining apparatus may send first information to a first node, that is, information related to a processing requirement between multiple streams or multiple packets, so that the first node can receive the first information. The processing requirement includes at least one of a coordination requirement or a synchronization requirement to obtain a coordination requirement, a synchronization requirement, or the like between streams. Therefore, the first node can define coordination and synchronization between multiple streams based on the information related to the processing requirement between multiple streams or multiple packets, so as to perform effective per-stream or per-packet coordination and synchronization processing to satisfy the processing requirement between multiple streams or multiple packets.

In a possible implementation, the first information includes at least one of the following: synchronization requirement information, coordination requirement information, processing object information, an uplink indication, a downlink indication, a processing mark, a time tag, a processing association relationship, or an indication of whether the processing requirement is satisfied.

The processing object information is information about an object having the processing requirement; the uplink indication is used to indicate an uplink processing requirement, and the downlink indication is used to indicate a downlink processing requirement; the processing mark is used to indicate that a first stream or a first packet has the processing requirement; the time tag is used to indicate time information corresponding to second stream or a second packet; and the processing association relationship is used to indicate an association relationship between packets or streams having the processing requirement.

In a possible implementation, the information about the object having the processing requirement includes at least one of the following:
an identifier of a terminal pair or a terminal group;
an identifier of a stream pair or a stream group;
an identifier of a QoS flow pair or a QoS flow group;
an identifier of a DRB pair or a DRB group;
an identifier of a bearer pair or a bearer group;
an identifier of a PDU session pair or a PDU session group; or
an identifier of a service pair or a service group.

In a possible implementation, the terminal pair or the terminal group includes at least one of the following:
a terminal having the processing requirement;
a terminal on which a stream having the processing requirement is located;
a terminal on which a QoS flow having the processing requirement is located;
a terminal on which a DRB having the processing requirement is located;
a terminal on which a bearer having the processing requirement is located;
a terminal on which a PDU session having the processing requirement is located; or
a terminal on which a service having the processing requirement is located.

In a possible implementation, the information about the object having the processing requirement includes at least one of the following: an identifier of at least one terminal, an identifier of at least one stream, an identifier of at least one QoS flow, an identifier of at least one DRB, an identifier of at least one bearer, an identifier of at least one PDU session, an identifier of at least one service, identification information of at least one packet, identification information of at least one stream, type information of at least one packet, or type information of at least one stream.

In a possible implementation, the first stream includes at least one of the following:
a stream including the processing mark, a stream associated with the processing mark, or a stream associated with a stream or a packet including the processing mark; and
the first packet includes at least one of the following:
   a packet including the processing mark, a packet associated with the processing mark, or a packet associated with a packet or a stream including the processing mark.

In a possible implementation, the time tag is used to indicate at least one of the following time information:
information about time at which a first object arrives at the first node;
information about time at which the first object leaves the first node;
a processing delay of the first object at the first node; or
a remaining delay requirement of the first object; where
the first object includes at least one of the following:
   a stream, a QoS flow, a DRB, a bearer, a PDU session, a service, or a packet.

In a possible implementation, the second stream includes at least one of the following:
a stream including the time tag, a stream associated with the time tag, and a stream associated with a stream or a packet including the time tag; and
the second packet includes at least one of the following:
   a packet including the time tag, a packet associated with the time tag, or a packet associated with a packet or a stream including the time tag.

In a possible implementation, the first node and the second node are different nodes; and
the first node is a base station, and the second node is a terminal; or
the first node is a core network node, and the second node is a base station or a terminal; or
the first node is a server, and the second node is a core network node or a terminal; or the first node is a terminal, and the second node is any one of the following: a base station, a core network node, and a server.

In a possible implementation, the first node and the second node are different protocol layers in a same node, the first node is a first protocol layer, and the second node is a second protocol layer; and
the first protocol layer is any one of the following:
   an IP layer, a TCP layer, and a UDP layer, and the second protocol layer is an SDAP layer; or
   the first protocol layer is an SDAP layer, and the second protocol layer is a PDCP layer; or
   the first protocol layer is a PDCP layer, and the second protocol layer is an RLC layer; or
   the first protocol layer is an RLC layer, and the second protocol layer is a MAC layer; or
   the first protocol layer is a MAC layer, and the second protocol layer is a PHY layer.

In a possible implementation, the first information is carried in a user plane message; or
the first information is carried in a control plane message; or
a first portion of information in the first information is carried in a control plane message, and a second portion of information in the first information is carried in a user plane message.

In a possible implementation, the first information is carried in a user plane message, and the first information includes at least one of the following: synchronization requirement information, coordination requirement information, processing object information, a processing mark, a time tag, a processing association relationship, or an indication of whether the processing requirement is satisfied.

In a case that the first node receives the first information, the object in which the first information is located or with which the first information is associated has the processing requirement.

In a possible implementation, the first information includes at least one of the following: processing object information, a processing mark, a time tag, a processing association relationship, or an indication of whether the processing requirement is satisfied.

The processing requirement is satisfied by satisfying a delay requirement of the first object, the first object includes at least one of the following: a stream, a QoS flow, a DRB, a bearer, a PDU session, a service, or a packet, and the delay requirement includes at least one of the following: a PSDB requirement, a PDB requirement, or a transmission delay requirement.

In a possible implementation, the first portion of information in the first information is carried in a control plane message, and the second portion of information in the first information is carried in a user plane message.

The first portion of information includes at least one of the following: a processing mark, a processing association relationship, or an indication of whether the processing requirement is satisfied. The second portion of information includes at least one of the following: synchronization requirement information, coordination requirement information, processing object information, or a time tag.

In a case that the first node receives the first portion of information, the object in which the first information is located or with which the first information is associated has the processing requirement.

In a possible implementation, in a case that the first node receives the first portion of information and does not receive the second portion of information, the processing requirement is satisfied by satisfying the delay requirement of the first object. The first object includes at least one of the following: a stream, a QoS flow, a DRB, a bearer, a PDU session, a service, or a packet, and the delay requirement includes at least one of the following: a PSDB requirement, a PDB requirement, or a transmission delay requirement.

In a possible implementation, in a case that the first node receives the first portion of information and the received second portion of information includes synchronization requirement information and coordination requirement information, the processing requirement is the synchronization requirement or the coordination requirement.

In a possible implementation, the user plane message includes at least one of the following:
a GTP-U message or a GTP-U message header;
a PDU set message or a PDU set message header;
a PDU message or a PDU message header;
an SDAP PDU message header;
a PDCP PDU message header;
an RLC PDU message header; or
a MAC CE message.

In a possible implementation, the first information is carried in a control plane message, and the first information includes at least one of the following: synchronization requirement information, coordination requirement information, processing object information, a processing mark, a processing association relationship, or an indication of whether the processing requirement is satisfied.

In a case that the first node receives the first information, the object in which the first information is located or with which the first information is associated has the processing requirement.

In a possible implementation, the control plane message includes at least one of the following:
a GTP-C message or
a GTP-C message header;
an RRC message; or
a NAS message.

In a possible implementation, in a case that the first information is uplink information, the RRC message includes either of the following:
a UAI message and a connection setup message; or
in a case that the first information is downlink information, the RRC message includes either of the following:
   an RRC configuration message and an RRC reconfiguration message.

In a possible implementation, in a case that the first information is uplink information, the NAS message includes any one of the following:
a service request message, a service accept message, and an identity request message;
or
in a case that the first information is downlink information, the NAS message includes either of the following:
   a service response message and an identity response message.

In a possible implementation, the packet includes at least two packets in a same second object or different second objects, and the second object includes at least one of the following: an associated user equipment group, user equipment, a stream, a QoS flow, an IP layer or a UDP layer, a burst, a bearer, a PDU session, a PDU set, a PDU, a DRB, or a service.

The information obtaining apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a network attached storage (NAS), or the like. This is not limited in this embodiment of this application.

The information obtaining apparatus provided in this embodiment of this application can implement the processes implemented in the foregoing embodiments of the information obtaining method, and achieve the same technical effect. To avoid repetition, details are not described herein again.

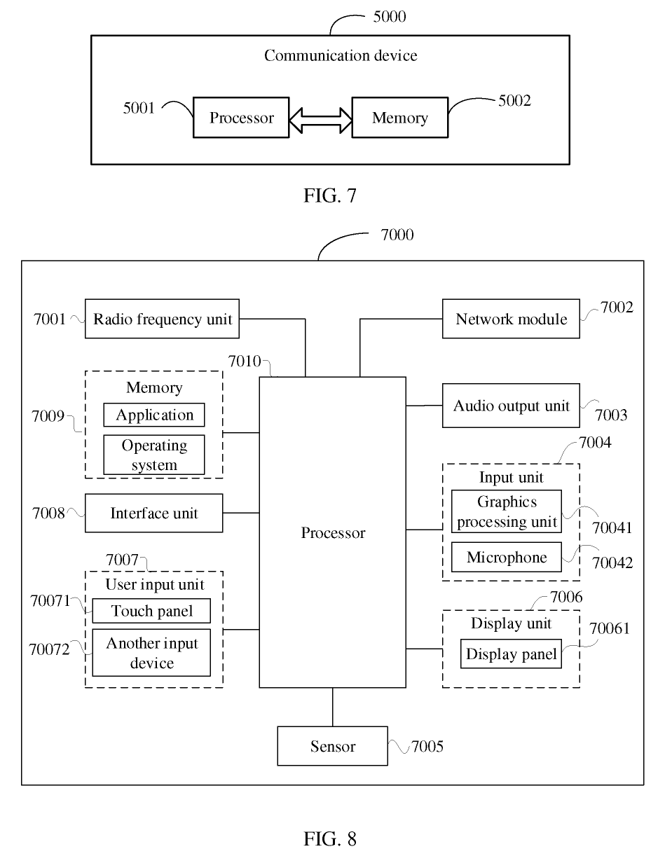

As shown in FIG. 7, an embodiment of this application further provides a communication device 5000, including a processor 5001 and a memory 5002, and the memory 5002 stores a program or instructions executable on the processor 5001. For example, when the communication device 5000 is the first node, the program or instructions are executed by the processor 5001 to implement the steps in the foregoing method embodiment on a first node side, and the same technical effect can be achieved. To avoid repetition, details are not described herein again. When the communication device 5000 is the second node, the program or instructions are executed by the processor 5001 to implement the steps in the foregoing method embodiment on a second node side, and the same technical effect can be achieved. To avoid repetition, details are not described herein again.

It should be noted that, in this embodiment of this application, the first node may be a terminal, or the first node may be a base station, a core network node, or a server of a network side device. The second node may be a terminal, or the second node may be a base station, a core network node, or a server of a network side device. Hardware structures of the terminal and the network side device are respectively illustrated in the following embodiments.

An embodiment of this application further provides a terminal, including a processor and a communication interface. The communication interface is coupled to the processor, and the processor is configured to run a program or instructions, to implement the steps in the foregoing embodiments of the information obtaining method. The terminal embodiment corresponds to the method embodiment on the first node side or the second node side, each implementation process and implementation of the method embodiment can be applied to the terminal embodiment, and the same technical effect can be achieved. Optionally, FIG. 8 is a schematic diagram of a hardware structure of a terminal according to an embodiment of this application.

The terminal 7000 includes but is not limited to at least a part of components such as a radio frequency unit 7001, a network module 7002, an audio output unit 7003, an input unit 7004, a sensor 7005, a display unit 7006, a user input unit 7007, an interface unit 7008, a memory 7009, and a processor 7010.

It may be understood by a person skilled in the art that the terminal 7000 may further include a power supply (such as a battery) that supplies power to each component. The power supply may be logically connected to the processor 7010 by using a power management system, to implement functions such as charging, discharging, and power consumption management by using the power management system. The terminal structure shown in FIG. 8 constitutes no limitation on the terminal, and the terminal may include more or fewer components than those shown in the figure, or combine some components, or have different component arrangements. Details are not described herein.

It should be understood that in this embodiment of this application, the input unit 7004 may include a graphics processing unit (GPU) 70041 and a microphone 70042. The graphics processing unit 70041 processes image data of a static picture or a video obtained by an image capture apparatus (for example, a camera) in a video capture mode or an image capture mode. The display unit 7006 may include a display panel 70061, and the display panel 70061 may be configured in a form of a liquid crystal display, an organic light-emitting diode, or the like. The user input unit 7007 includes at least one of a touch panel 70071 or another input device 70072. The touch panel 70071 is also referred to as a touchscreen. The touch panel 70071 may include two parts: a touch detection apparatus and a touch controller. The another input device 70072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 7001 may transmit the downlink data to the processor 7010 for processing. In addition, the radio frequency unit 7001 may send uplink data to the network side device. Generally, the radio frequency unit 7001 includes but is not limited to an antenna, an amplifier, a transceiver, a coupler, a low noise amplifier, a duplexer, and the like.

The memory 7009 may be configured to store a software program or an instruction and various data. The memory 7009 may mainly include a first storage area for storing a program or an instruction and a second storage area for storing data. The first storage area may store an operating system, and an application or an instruction required by at least one function (for example, a sound playing function or an image playing function). In addition, the memory 7009 may include a volatile memory or a non-volatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synch link dynamic random access memory (SLDRAM), and a direct rambus random access memory (DRRAM). The memory 7009 in this embodiment of this application includes but is not limited to these memories and any memory of another proper type.

The processor 7010 may include one or more processing units. Optionally, an application processor and a modem processor are integrated into the processor 7010. The application processor mainly processes an operating system, a user interface, an application, or the like. The modem processor mainly processes a wireless communication signal, for example, a baseband processor. It may be understood that, alternatively, the modem processor may not be integrated into the processor 7010.

The terminal provided in this embodiment of this application can implement processes implemented by the first node or the second node in the foregoing method embodiments, and the same technical effect is achieved. For an implementation process of each implementation mentioned in this embodiment, reference may be made to related descriptions in the foregoing embodiments of the information obtaining method. To avoid repetition, details are not described herein again.

An embodiment of this application further provides a network side device, including a processor and a communication interface. The communication interface is coupled to the processor, and the processor is configured to run a program or instructions to implement the steps in the foregoing embodiments of the information obtaining method. This embodiment of the network side device corresponds to the foregoing method embodiment on the first node side or the second node side. Each implementation process and implementation manner of the foregoing method embodiment may be applicable to this embodiment of the network side device, and the same technical effect can be achieved.

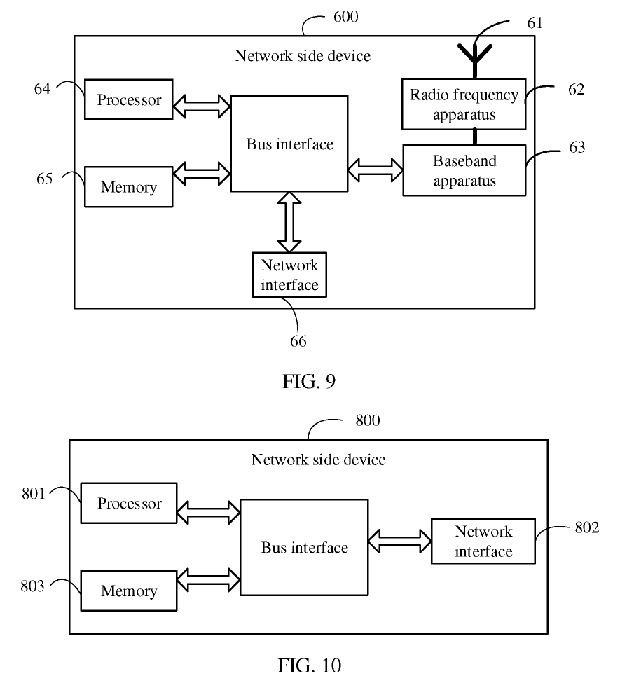

Optionally, an embodiment of this application further provides a network side device. As shown in FIG. 9, the network side device 600 includes an antenna 61, a radio frequency apparatus 62, a baseband apparatus 63, a processor 64, and a memory 65. The antenna 61 is connected to the radio frequency apparatus 62. In an uplink direction, the radio frequency apparatus 62 receives information through the antenna 61, and sends the received information to the baseband apparatus 63 for processing. In a downlink direction, the baseband apparatus 63 processes information that needs to be sent, and sends processed information to the radio frequency apparatus 62. The radio frequency apparatus 62 processes the received information, and sends processed information through the antenna 61.

In the foregoing embodiment, the method performed by the network side device may be implemented in the baseband apparatus 63. The baseband apparatus 63 includes a baseband processor.

For example, the baseband apparatus 63 may include at least one baseband board. A plurality of chips are disposed on the baseband board. As shown in FIG. 9, one chip is, for example, a baseband processor, and is connected to the memory 65 by using a bus interface, to invoke a program in the memory 65 to perform the operations of the network device shown in the foregoing method embodiment.

The network side device may further include a network interface 66, and the interface is, for example, a common public radio interface (CPRI).

Optionally, the network side device 600 in this embodiment of this application further includes an instruction or a program stored in the memory 65 and executable on the processor 64. The processor 64 invokes the instruction or the program in the memory 65 to perform the method performed by the modules of the information obtaining apparatus, and the same technical effect is achieved. To avoid repetition, details are not described herein again.

Optionally, an embodiment of this application further provides a network side device. As shown in FIG. 10, a network side device 800 includes a processor 801, a network interface 802, and a memory 803. The network interface 802 is, for example, a common public radio interface (CPRI).

Optionally, the network side device 800 in this embodiment of this application further includes an instruction or a program stored in the memory 803 and executable on the processor 801. The processor 801 invokes the instruction or the program in the memory 803 to perform the method performed by the modules of the information obtaining apparatus, and the same technical effect is achieved. To avoid repetition, details are not described herein again.

An embodiment of this application further provides a non-transitory readable storage medium. The non-transitory readable storage medium stores a program or instructions, and when the program or instructions are executed by a processor, the processes of the foregoing embodiments of the information obtaining method are performed, and the same technical effect can be achieved. To avoid repetition, details are not described herein again.

The processor is a processor in the terminal in the foregoing embodiments. The non-transitory readable storage medium includes a non-transitory computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or instructions to implement the processes of the foregoing embodiments of the information obtaining method, and the same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product, the computer program/program product is stored in a non-volatile storage medium, and the computer program/program product is executed by at least one processor to implement the processes of the foregoing embodiments of the information obtaining method, and the same technical effect can be achieved. To avoid repetition, details are not described herein again.

An embodiment of this application further provides a wireless communication system, including a first node and a second node. The first node may be configured to perform the steps of the foregoing information obtaining method, and the second node may be configured to perform the steps of the foregoing information obtaining method.

It should be noted that, in this specification, the term "include", "comprise", or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by "includes a..." does not preclude the existence of other identical elements in the process, method, article, or apparatus that includes the element. In addition, it should be noted that the scope of the method and the apparatus in the implementations of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by a computer software product in addition to a necessary universal hardware platform or certainly by hardware. The computer software product is stored in a storage medium (such as a ROM, a RAM, a magnetic disk, or an optical disc), and includes several instructions for indicating a terminal or a network side device to perform the methods described in the embodiments of this application.

The embodiments of this application are described above with reference to the accompanying drawings, but this application is not limited to the foregoing implementations, and the foregoing implementations are only illustrative and not restrictive. Under the enlightenment of this application, a person of ordinary skill in the art can make many forms of implementations without departing from the purpose of this application and the protection scope of the claims, all of which fall within the protection of this application.

What is claimed is:

1. An information obtaining method, comprising:
receiving, by a first node, first information from a second node, wherein the first information is information related to a processing requirement between multiple streams or multiple packets, and the processing requirement comprises at least one of the following: a coordination requirement or a synchronization requirement; wherein
the first node and the second node are different nodes, or the first node and the second node are different protocol layers in a same node.

2. The method according to claim 1, wherein the first information comprises at least one of the following: synchronization requirement information, coordination requirement information, processing object information, an uplink indication, a downlink indication, a processing mark, a time tag, a processing association relationship, or an indication of whether the processing requirement is satisfied; and
the processing object information is information about an object having the processing requirement; the uplink indication is used to indicate an uplink processing requirement, and the downlink indication is used to indicate a downlink processing requirement; the processing mark is used to indicate that a first stream or a first packet has the processing requirement; the time tag is used to indicate time information corresponding to a second stream or a second packet; and the processing association relationship is used to indicate an association relationship between packets or streams having the processing requirement.

3. The method according to claim 2, wherein the information about the object having the processing requirement comprises at least one of the following:
an identifier of a terminal pair or a terminal group;
an identifier of a stream pair or a stream group;
an identifier of a quality of service (QoS) flow pair or a QoS flow group;
an identifier of a data radio bearer (DRB) pair or a DRB group;
an identifier of a bearer pair or a bearer group;
an identifier of a protocol data unit (PDU) session pair or a PDU session group; or
an identifier of a service pair or a service group;
wherein the terminal pair or the terminal group comprises at least one of the following:
a terminal having the processing requirement;
a terminal on which a stream having the processing requirement is located;
a terminal on which a QoS flow having the processing requirement is located;
a terminal on which a DRB having the processing requirement is located;
a terminal on which a bearer having the processing requirement is located;
a terminal on which a PDU session having the processing requirement is located; or
a terminal on which a service having the processing requirement is located.

4. The method according to claim 2, wherein the information about the object having the processing requirement comprises at least one of the following: an identifier of at least one terminal, an identifier of at least one stream, an identifier of at least one quality of service (QoS) flow, an identifier of at least one data radio bearer (DRB), an identifier of at least one bearer, an identifier of at least one protocol data unit (PDU) session, an identifier of at least one service, identification information of at least one packet, identification information of at least one stream, type information of at least one packet, or type information of at least one stream;
or,
the first stream comprises at least one of the following: a stream comprising the processing mark, a stream associated with the processing mark, or a stream associated with a stream or a packet comprising the processing mark; and
the first packet comprises at least one of the following: a packet comprising the processing mark, a packet associated with the processing mark, or a packet associated with a packet or a stream comprising the processing mark.

5. The method according to claim 2, wherein the time tag is used to indicate at least one of the following time information:
information about time at which a first object arrives at the first node;
information about time at which the first object leaves the first node;
a processing delay of the first object at the first node; or
a remaining delay requirement of the first object; wherein
the first object comprises at least one of the following: a stream, a quality of service (QoS) flow, a data radio bearer (DRB), a bearer, a protocol data unit (PDU) session, a service, or a packet;
or,
the second stream comprises at least one of the following: a stream comprising the time tag, a stream associated with the time tag, or a stream associated with a stream or a packet comprising the time tag; and
the second packet comprises at least one of the following: a packet comprising the time tag, a packet associated with the time tag, or a packet associated with a packet or a stream comprising the time tag.

6. The method according to claim 1, wherein the first node and the second node are different nodes; and
the first node is a base station, and the second node is a terminal; or
the first node is a core network node, and the second node is a base station or a terminal; or
the first node is a server, and the second node is a core network node or a terminal; or
the first node is a terminal, and the second node is any one of the following: a base station, a core network node, and a server.

7. The method according to claim 1, wherein the first node and the second node are different protocol layers in the same node, the first node is a first protocol layer, and the second node is a second protocol layer; and
the first protocol layer is any one of the following: an Internet protocol (IP) layer, a transmission control protocol (TCP) layer, and a user datagram protocol (UDP) layer, and the second protocol layer is a service data adaptation protocol (SDAP) layer; or
the first protocol layer is an SDAP layer, and the second protocol layer is a packet data convergence protocol (PDCP) layer; or
the first protocol layer is a PDCP layer, and the second protocol layer is a radio link control (RLC) layer; or
the first protocol layer is an RLC layer, and the second protocol layer is a medium access control (MAC) layer; or
the first protocol layer is a MAC layer, and the second protocol layer is a physical (PHY) layer.

8. The method according to claim 1, wherein the first information is carried in a user plane message; or
the first information is carried in a control plane message; or
a first portion of information in the first information is carried in a control plane message, and a second portion of information in the first information is carried in a user plane message.

9. The method according to claim 2, wherein the first information is carried in the user plane message, and the first information comprises at least one of the following: the synchronization requirement information, the coordination requirement information, the processing object information, the processing mark, the time tag, the processing association relationship, or the indication of whether the processing requirement is satisfied; wherein
in a case that the first node receives the first information, an object in which the first information is located or with which the first information is associated has the processing requirement;
wherein the first information comprises at least one of the following: the processing object information, the processing mark, the time tag, the processing association relationship, or the indication of whether the processing requirement is satisfied; and
the processing requirement is satisfied by satisfying a delay requirement of the first object, the first object comprises at least one of the following: a stream, a quality of service (QoS) flow, a data radio bearer (DRB), a bearer, a protocol data unit (PDU) session, a service, or a packet, and the delay requirement comprises at least one of the following: a PDU set delay budget (PSDB) requirement, a packet delay budget (PDB) requirement, or a transmission delay requirement.

10. The method according to claim 2, wherein the first portion of information in the first information is carried in the control plane message, and the second portion of information in the first information is carried in the user plane message;
the first portion of information comprises at least one of the following: the processing mark, the processing association relationship, or the indication of whether the processing requirement is satisfied; and the second portion of information comprises at least one of the following: the synchronization requirement information, the coordination requirement information, the processing object information, or the time tag; and
in a case that the first node receives the first portion of information, an object in which the first portion of information is located or with which the first portion of information is associated has the processing requirement.

11. The method according to claim 10, wherein in a case that the first node receives the first portion of information and does not receive the second portion of information, the processing requirement is satisfied by satisfying the delay requirement of the first object, the first object comprises at least one of the following: a stream, a quality of service (QoS) flow, a data radio bearer (DRB), a bearer, a protocol data unit (PDU) session, a service, or a packet, and the delay requirement comprises at least one of the following: a PDU set delay budget (PSDB) requirement, a packet delay budget (PDB) requirement, or a transmission delay requirement;
or,
in a case that the first node receives the first portion of information, and the received second portion of information comprises the synchronization requirement information and the coordination requirement information, the processing requirement is the synchronization requirement or the coordination requirement.

12. The method according to claim 8, wherein the user plane message comprises at least one of the following:
a general packet radio service tunnel protocol-user plane (GTP-U) message or a GTP-U message header;
a protocol data unit (PDU) set message or a PDU set message header;
a PDU message or a PDU message header;
an service data adaptation protocol (SDAP) PDU message header;
a packet data convergence protocol (PDCP) PDU message header;
an radio link control (RLC) PDU message header; or
a medium access control (MAC) control element (CE) message.

13. The method according to claim 2, wherein the first information is carried in the control plane message, and the first information comprises at least one of the following: the synchronization requirement information, the coordination requirement information, the processing object information, the processing mark, the processing association relationship, or the indication of whether the processing requirement is satisfied; and
in a case that the first node receives the first information, an object in which the first information is located or with which the first information is associated has the processing requirement.

14. The method according to claim 8, wherein the control plane message comprises at least one of the following:
a general packet radio service tunnel protocol-control plane (GTP-C) message or a GTP-C message header;
a radio resource control (RRC) message; or
a non-access stratum (NAS) message.

15. The method according to claim 14, wherein in a case that the first information is uplink information, the RRC message comprises either of the following: a user equipment assistance information (UAI) message and a connection setup message;
or
in a case that the first information is downlink information, the RRC message comprises either of the following: an RRC configuration message and an RRC reconfiguration message;
or,
in a case that the first information is uplink information, the NAS message comprises any one of the following: a service request message, a service accept message, and an identity request message;
or
in a case that the first information is downlink information, the NAS message comprises either of the following: a service response message and an identity response message.

16. The method according to claim 2, wherein the packet comprises at least two packets in a same second object or different second objects; and
the second object comprises at least one of the following: an associated user equipment group, user equipment, a stream, a quality of service (QoS) flow, an Internet protocol (IP) layer or a user datagram protocol (UDP) layer, a burst, a bearer, a protocol data unit (PDU) session, a PDU set, a PDU, a data radio bearer (DRB), or a service.

17. The method according to claim 1, wherein after the receiving, by a first node, first information from a second node, the method further comprises:
performing, by the first node, first processing between multiple streams or multiple packets based on the first information, wherein the first processing comprises at least one of the following: coordination processing or synchronization processing.

18. An information obtaining method, comprising:
sending, by a second node, first information to a first node, wherein the first information is information related to a processing requirement between multiple streams or multiple packets, and the processing requirement comprises at least one of the following: a coordination requirement or a synchronization requirement; wherein
the first node and the second node are different nodes, or the first node and the second node are different protocol layers in a same node.

19. A communication device, the communication device being a first node and comprising a processor and a memory, wherein the memory stores a program or instructions executable on the processor, and the program or instructions, when executed by the processor, cause the first node to perform:
receiving first information from a second node, wherein the first information is information related to a processing requirement between multiple streams or multiple packets, and the processing requirement comprises at least one of the following: a coordination requirement or a synchronization requirement; wherein
the first node and the second node are different nodes, or the first node and the second node are different protocol layers in a same node.

20. A communication device, comprising a processor and a memory, wherein the memory stores a program or instructions executable on the processor, and when the program or instructions are executed by the processor, the steps of the information obtaining method according to claim 18 are implemented.
